(19) United States
(12) Patent Application Publication
(10) Pub. No.: US 2016/0054342 A1
(43) Pub. Date: Feb. 25, 2016

(54) IN-VITRO DIAGNOSTIC APPARATUS AND IN-VITRO DIAGNOSTIC TEST METHOD

(71) Applicant: SAMSUNG ELECTRONICS CO., LTD., Suwon-si (KR)

(72) Inventors: Yu-ri SON, Gunpo-si (KR); Ki-ju LEE, Suwon-si (KR)

(73) Assignee: SAMSUNG ELECTRONICS CO., LTD., Suwon-si (KR)

(21) Appl. No.: 14/828,691

(22) Filed: Aug. 18, 2015

(30) Foreign Application Priority Data
Aug. 22, 2014 (KR) 10-2014-0109962

(51) Int. Cl. G01N 35/00

(52) U.S. Cl. CPC G01N 35/00732; G01N 35/00069; G01N 2035/00841; G01N 2035/0091

(57) ABSTRACT

An in-vitro diagnostic apparatus includes a controller configured to set a test result reference range corresponding to a condition of a testee, among test result reference ranges corresponding to a plurality of conditions, with respect to a test item of a test object, and generate a user interface screen including the set test result reference range; and a display configured to display the user interface screen.

### CROSS-REFERENCE TO RELATED APPLICATION

This application claims priority from Korean Patent Application No. 10-2014-0109962, filed on Aug. 22, 2014, in the Korean Intellectual Property Office, the disclosure of which is incorporated herein in its entirety by reference.

### BACKGROUND

1. Field

Apparatuses and methods consistent with exemplary embodiments relate to an in-vitro diagnostic apparatus and an in-vitro diagnostic test method, and more particularly, to an in-vitro diagnostic apparatus and an in-vitro diagnostic test method capable of providing test result reference ranges based on physical information of a testee.

2. Description of the Related Art

An in-vitro diagnosis is a technique of checking the health of a testee based on a test object such as blood, body fluid, etc. that can be collected from the testee, and has been widely used as a pre-diagnosis method to determine a disease.

A blood test apparatus, which is an example of an in-vitro diagnostic apparatus, is capable of checking the health of a testee by using a small amount of blood collected from the testee. By using the blood test apparatus, a user may easily obtain diagnostic information of a testee. Other examples of the in-vitro diagnostic apparatus may include an immunological test apparatus, a blood sugar test apparatus, etc.

The in-vitro diagnostic apparatus may provide a reference range for determining whether a test result is normal. The reference range is, however, not an absolute reference range for determining the health of a testee, e.g., whether the testee is infected with a disease, and may be used as a reference for a user (e.g., a doctor) of the in-vitro diagnostic apparatus to check the health of the testee.

A test result reference range may depend on a physical condition of a testee. For example, a test result reference range for a test item with respect to a testee who is in twenties or thirties may be different from a test result reference range for the test item with respect to a testee who is in seventies or eighties. However, a related art in-vitro diagnostic apparatus simply provides a default reference range for each test item. Thus, a user needs to perform an in-vitro diagnostic test by modifying the default reference range as needed, and analyze a result of the test based on the modified default reference range.

Accordingly, there is a need to develop an in-vitro diagnostic apparatus and an in-vitro diagnostic test method capable of providing various test result reference ranges corresponding to conditions of a testee to perform precise diagnosis.

### SUMMARY

One or more exemplary embodiments provide an in-vitro diagnostic apparatus and an in-vitro diagnostic test method capable of providing various test result reference ranges for a test item.

Also, one or more exemplary embodiments provide an in-vitro diagnostic apparatus and an in-vitro diagnostic test method capable of setting test result reference ranges, which correspond to conditions including at least one piece of physical information of the testee, with respect to a test item of a test object.

Additional aspects will be set forth in part in the description which follows and, in part, will be apparent from the description, or may be learned by practice of the exemplary embodiments.

According to an aspect of an exemplary embodiment, provided is an in-vitro diagnostic apparatus including: a controller configured to set a test result reference range corresponding to a condition of a testee, among test result reference ranges corresponding to a plurality of conditions with respect to a test item of a test object, and generate a user interface screen including the set test result reference range; and a display configured to display the user interface screen.

The in-vitro diagnostic apparatus may further include a storage configured to store the plurality of conditions and the test result reference ranges corresponding to the plurality of conditions with respect to the test item of the test object.

The controller may be configured to set the test result reference range based on a first test result reference range corresponding to a first condition, the first condition matching at least one physical information of the testee.

The in-vitro diagnostic apparatus may further include a user interface configured to receive an input for setting the test result reference range via the user interface screen.

The user interface may be configured to receive a first input for performing at least one of adding, modifying, or deleting a certain condition or a certain test result reference range with respect to the plurality of conditions and the test result reference ranges corresponding to the plurality of conditions, which are stored in the storage, wherein the controller is configured to perform the at least one of adding, modifying, or deleting the certain condition or the certain test result reference range based on the first input.

The user interface may be configured to receive a second input for selecting the first condition among the plurality of conditions.

The controller may be configured to set the condition of the testee based on the selected first condition.

The user interface is configured to receive a third input for modifying the set condition of the testee, wherein the controller is configured to generate a first notification signal when the modified condition of the testee does not match the first condition

The first notification signal may include at least one from among a visual signal, a tactile signal, and an audio signal.

The user interface may be configured to receive a fourth input for setting the condition of the testee, wherein the controller is configured to set, as the condition of the testee, the first condition matching the at least one physical information of the testee among the plurality of conditions, in response to the fourth input.

The controller may be configured to detect a plurality of first conditions matching the at least one physical information of the testee, among the plurality of conditions, wherein the user interface is configured to receive a fifth input for selecting the first condition among the plurality of first conditions.

The condition of the testee may include at least one from among a race, a gender, an age, a height, and a weight.

The in-vitro diagnostic apparatus may further include a loader configured to load a test medium containing the test object; and an analyzer configured to analyze the test object in response to a control of the controller.

The controller may be configured to generate a second notification signal when a result of analyzing the test object is not within the test result reference range.

The second notification signal may include at least one from among a visual signal, a tactile signal, and an audio signal.

According to an aspect of an exemplary embodiment, provided is an in-vitro diagnostic test method including: setting a test result reference range corresponding to a condition of a testee, among test result reference ranges corresponding to a plurality of conditions with respect to a test item of a test object; generating a user interface screen including the set test result reference range; and displaying the user interface screen.

The in-vitro diagnostic apparatus may further include storing the plurality of conditions and the test result reference ranges corresponding to the plurality of conditions with respect to the test item of the test object.

The setting may include setting the test result reference range based on a first test result reference range corresponding to a first condition, the first condition matching at least one physical information of the testee.

The in-vitro diagnostic apparatus may further include receiving an input for setting the test result reference range via the user interface screen.

According to an aspect of an exemplary embodiment, provided is a non-transitory computer-readable recording medium having recorded thereon a program which, when executed by a computer, causes the computer to perform an in-vitro diagnostic test method including: setting a test result reference range corresponding to a condition of a testee, among test result reference ranges corresponding to a plurality of conditions with respect to a test item of a test object; generating a user interface screen including the set test result reference range; and displaying the user interface screen.

### BRIEF DESCRIPTION OF THE DRAWINGS

The above and/or other aspects will be more apparent by describing certain example embodiments with reference to the accompanying drawings:

FIGS. 1A and 1B illustrate in-vitro diagnostic apparatuses according to exemplary embodiments;

FIGS. 2A and 2B illustrate respective test media to be used in the respective in-vitro diagnostic apparatuses of FIGS. 1A and 1B according to exemplary embodiments;

FIG. 3 is a block diagram of an in-vitro diagnostic apparatus according to an exemplary embodiment;

FIG. 4 is a block diagram of an in-vitro diagnostic apparatus according to another exemplary embodiment;

FIG. 5 is a diagram illustrating an operation of an in-vitro diagnostic apparatus, according to an exemplary embodiment;

FIGS. 6A, 6B, and 6C are diagrams illustrating operations of an in-vitro diagnostic apparatus, according to other exemplary embodiments;

FIG. 7 is a diagram illustrating an operation of an in-vitro diagnostic apparatus, according to still another exemplary embodiment;

FIGS. 8A and 8B are diagrams illustrating an operation of an in-vitro diagnostic apparatus, according to still another exemplary embodiment;

FIGS. 9A and 9B are diagrams illustrating an operation of an in-vitro diagnostic apparatus, according to still another exemplary embodiment;

FIGS. 10A, 10B, and 10C are diagrams illustrating an operation of an in-vitro diagnostic apparatus, according to still another exemplary embodiment;

FIG. 11 is a diagram illustrating an operation of an in-vitro diagnostic apparatus, according to still another exemplary embodiment; and

FIG. 12 is a flowchart of an in-vitro diagnostic test method according to an exemplary embodiment.

### DETAILED DESCRIPTION

Certain exemplary embodiments are described in greater detail below with reference to the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. Sizes of elements in the drawings may be exaggerated for convenience of explanation. In other words, since sizes and thicknesses of components in the drawings are arbitrarily illustrated for convenience of explanation, the following exemplary embodiments are not limited thereto.

General terms widely used are selected while considering functions in one or more exemplary embodiments for terms used herein, but the terms used herein may differ according to intentions of one of ordinary skill in the art, precedents, or emergence of new technologies. In some cases, an applicant arbitrarily selects a term, and in this case, the meaning of the term will be described in detail herein. Accordingly, the terms shall be defined based on the meanings and details throughout the specification, rather than the simple names of the terms.

It will be understood that the terms “comprise” and/or “comprising,” when used in the present disclosure, specify the presence of stated features, integers, steps, operations, elements, and/or components, but do not preclude the presence or addition of one or more other features, integers, steps, operations, elements, components, and/or groups thereof. The term “unit” used herein should be understood as software or a hardware component such as a field programmable gate array (FPGA) or an application specific integrated circuit (ASIC) that performs some functions. However, the term “unit” is not limited to software and hardware, and may be understood as a component that may be included in a storage medium that is addressable or that may be configured to drive at least one processor. For example, the term “unit” should be understood as including components such as software components, object-oriented software components, class components, and task components; processes, functions, attributes, procedures, subroutines, code segments, drivers, firmware, microcode, circuits, data, a database, data structures, tables, arrays, parameters, etc. Functions performed in components and units may be combined such that they are performed in a smaller number of components and a smaller number of units or may be divided into sub-functions such that they are performed by additional components and units.

Hereinafter, exemplary embodiments will be described in detail so that those of ordinary skill in the art can easily implement the inventive concept based on the appended drawings. For clarity, descriptions of components of the inventive concept that are not related to describing exemplary embodiments are may be omitted.

In the present disclosure, the term ‘user’ may be understood as, but is not limited to, a medical professional such as an emergency medical technician, a doctor, a nurse, a medical laboratory technologist, a medical image specialist, etc., or a medical apparatus repairman. As used herein, expressions such as “at least one of,” when preceding a list of elements, modify the entire list of elements and do not modify the individual elements of the list.

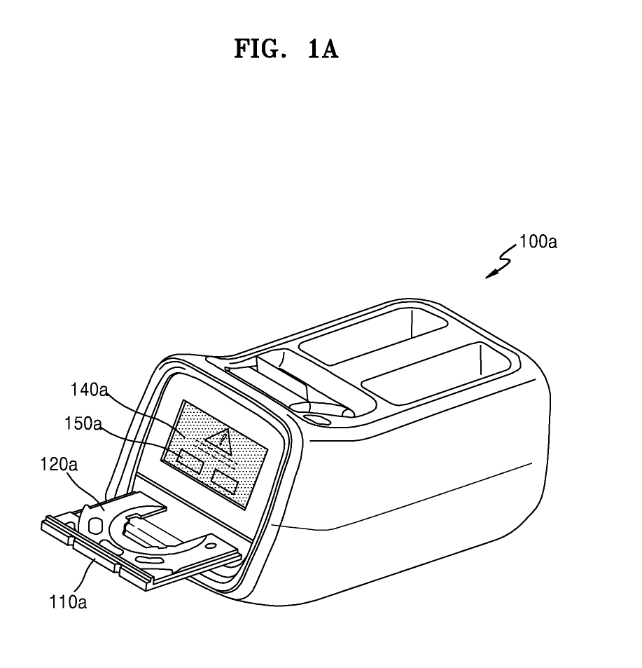

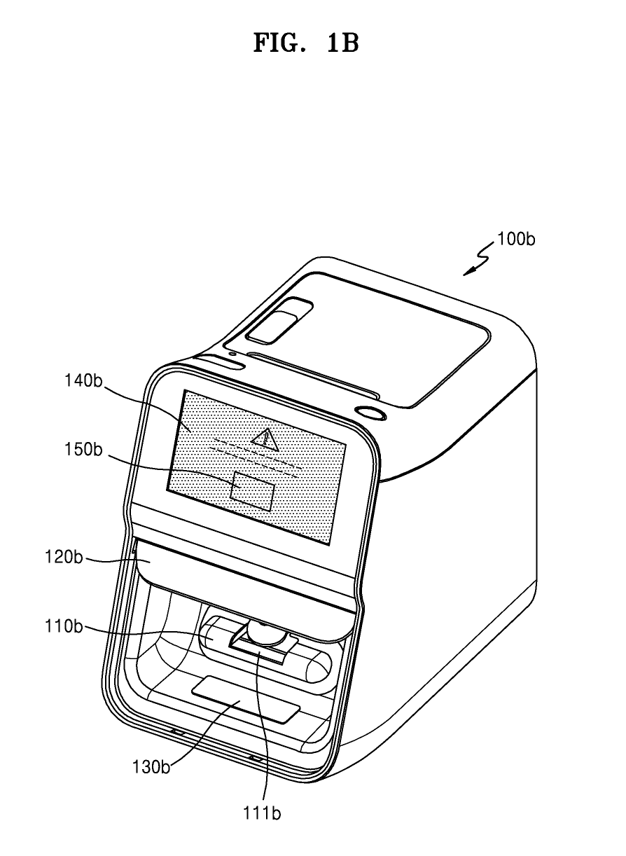

FIGS. 1A and 1B illustrate in-vitro diagnostic apparatuses according to exemplary embodiments.

When an in-vitro diagnostic apparatus includes a disc-type blood test apparatus that uses a disc-type test medium, the disc-type blood test apparatus may be configured as illustrated in FIG. 1A.

A disc-type blood test apparatus 100a receives a test medium containing blood collected from a patient via a test medium insertion surface 120a of a loader 110a, analyzes the blood contained in the test medium, and outputs a result of analyzing the blood via a display 140a.

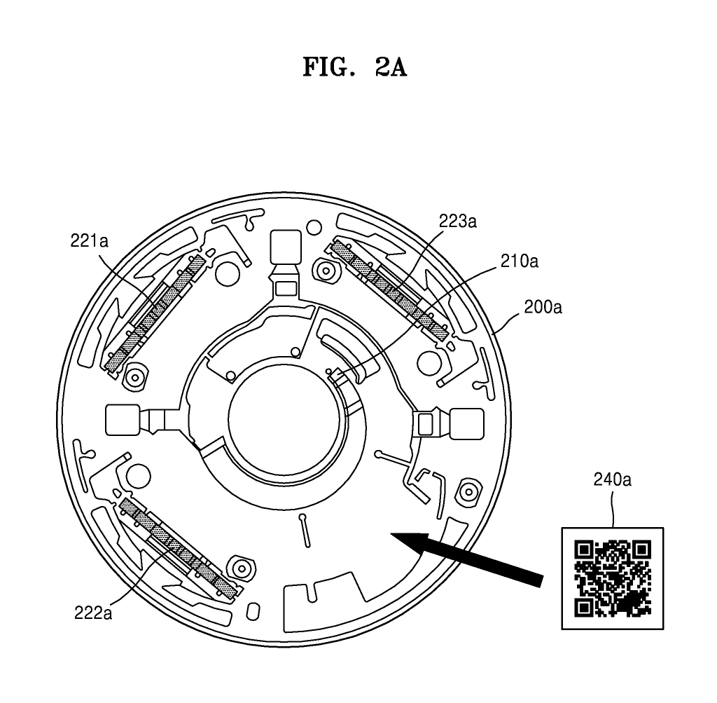

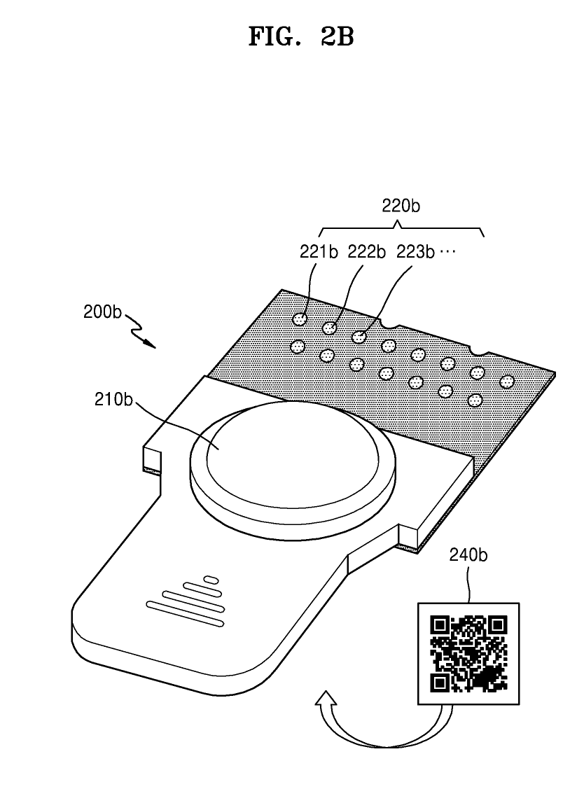

Here, the test medium is provided to include the blood, which is an object to be tested. The test medium may have a disc form, a cartridge form, etc. A disc-type test medium according to an exemplary embodiment that may be used in the disc-type blood test apparatus 100a of FIG. 1A will be described in detail with reference to FIG. 2A later.

A test object such as blood is collected or obtained from a testee (or a patient).

Also, the disc-type blood test apparatus 100a may start a blood test by using a trigger signal indicating the start of the test. For example, the display 140a may include a touch screen provided by combining a display panel and a touch pad. In this case, a user interface screen, which is a menu screen for performing a blood test, may be displayed on the display 140a. Here, a user may start the blood test by touching a button 150a displayed on the menu screen.

When the in-vitro diagnostic apparatus includes a cartridge-type blood test apparatus using a cartridge-type test medium, the cartridge-type blood test apparatus may be configured as illustrated in FIG. 1B.

A cartridge-type test medium to be used in a cartridge-type blood test apparatus 100b as illustrated in FIG. 1B according to another exemplary embodiment will be described in detail with reference to FIG. 2B later.

The cartridge-type blood test apparatus 100b may start a test of blood by using a trigger signal indicating the start of the test. For example, a display 140b may include a touch screen provided by combining a display panel and a touch pad. In this case, a user interface screen, which is a menu screen for performing a blood test, may be displayed on the display 140b. Here, a user may start the blood test by touching a button 150b displayed on the menu screen.

When the button 150b is touched, the cartridge-type blood test apparatus 100b enters a standby mode to start the test. In the standby mode, the cartridge-type blood test apparatus 100b receives a cartridge containing blood collected from a patient via a test medium insertion surface 111b of a loader 110b. When a lid 120b is closed, the cartridge-type blood test apparatus 100b that receives the cartridge containing the blood analyzes the blood and outputs a result of analyzing the blood via the display 140b.

The disc-type blood test apparatus 100a and the cartridge-type blood test apparatus 100b may be provided in a small size to be easily carried, as illustrated in FIGS. 1A and 1B, and may be installed in various transfer devices for transferring an emergency patient, e.g., an ambulance or an ambulance helicopter, etc.

FIGS. 2A and 2B illustrate respective test media to be used in the in-vitro diagnostic apparatuses 100a and 100b of FIGS. 1A and 1B according to exemplary embodiments.

When a test medium includes a disc for a blood test, the disc for a blood test may be configured as illustrated in FIG. 2A.

Referring to FIG. 2A, blood collected from a patient is injected into a blood test disc 200a, which is a test medium, via an injection hole 210a. The injected blood is spread into at least one strip among strips 221a, 222a, and 223a that are included in the blood test disc 200a.

The blood test disc 200a may store identification information 240a for identifying the test medium. The identification information 240a may be formed as a quick-response (QR) code and attached to a front surface of the blood test disc 200a, as illustrated in FIG. 2A.

The identification information 240a of the test medium may include information regarding at least one of the test object and the test medium. For example, identification information 240a of the test medium may include physical information (e.g., a race, a gender, an age, a height, a weight, etc.) of a testee, the expiry date of the test medium, etc.

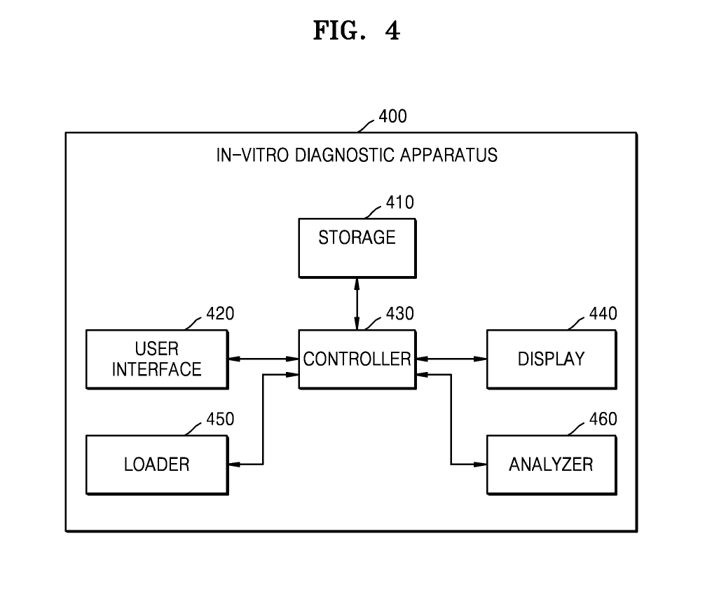

An analyzer 460 of an in-vitro diagnostic apparatus 400 (refer to FIG. 4) analyzes a test object such as blood contained in the test medium. For example, the analyzer 460 included in the disc-type blood test apparatus 100a of FIG. 1A may precisely analyze the blood contained in at least one strip among the strips 221a, 222a, and 223a that are included in the blood test disc 200a.

The analyzer 460 may perform a predetermined test. The analyzer 460 may perform the predetermined test to determine whether a patient is infected with a predetermined disease, based on the identification information 240a. Also, the analyzer 460 may perform the predetermined test to determine whether the patient is infected with the predetermined disease, based on user settings or initial settings of the in-vitro diagnostic apparatus 400.

For example, the analyzer 460 may perform a troponin I (TnI) test on blood, which is a test object. The TnI test is a cardiac marker test performed to diagnose acute myocardial infarction (AMI) and/or acute coronary syndrome (ACS). When there is an emergency patient who suffers from myocardial infarction, the TnI test, which is a cardiac marker test, may be performed. The TnI is a myocardial injury indicator and occurs in blood when myocardial tissue is damaged.

As another example, when a test medium includes a blood test cartridge, the blood test cartridge may be configured as illustrated in FIG. 2B.

Referring to FIG. 2B, blood collected from a patient is injected into a blood test cartridge 200b, which is a test medium, via an injection hole 210b. The injected blood is spread into at least one well among a plurality of wells 220b including wells 221b, 222b, and 223b that are included in the blood test cartridge 200b.

The injection hole 210 may include a filter. The filter included in the injection hole 210b may separate a blood component such as plasma or serum, which is needed to perform a blood test, from the blood. The separated blood component is spread into wells 220b of the blood test cartridge 200b.

The blood test cartridge 200b, which is a test medium, may store identification information 240b for identifying the test medium. The identification information 240b may be formed as QR code and attached to a rear surface of the blood test cartridge 200b, as illustrated in FIG. 2B.

Also, the cartridge-type blood test apparatus 100b of FIG. 1B may detected the identification information 240b attached to the blood test cartridge 200b via a sensor 130b.

The identification information 240b of the test medium may include information regarding at least one of the test object and the test medium. For example, the identification information 240b of the test medium may include physical information (the race, gender, age, height, weight, etc.) of a testee, the expiry date of the test medium, etc.

The analyzer 460 included in the disc-type blood test apparatus 100b of FIG. 1B may precisely analyze the blood contained in the wells 220b in the blood test cartridge 200b. The lid 120b of the cartridge-type blood test apparatus 100b of FIG. 1B is closed to block external light from being incident on the wells 220b of the blood test cartridge 200b. Also, the cartridge-type blood test apparatus 100b radiates light onto the wells 220b via a light radiator (not shown) therein. Also, the analyzer 460 included in the cartridge-type blood test apparatus 100b may precisely analyze the blood by analyzing a light absorption rate of a reactant between a reagent contained in the wells 220b and the blood with respect to the light radiated by the light radiator.

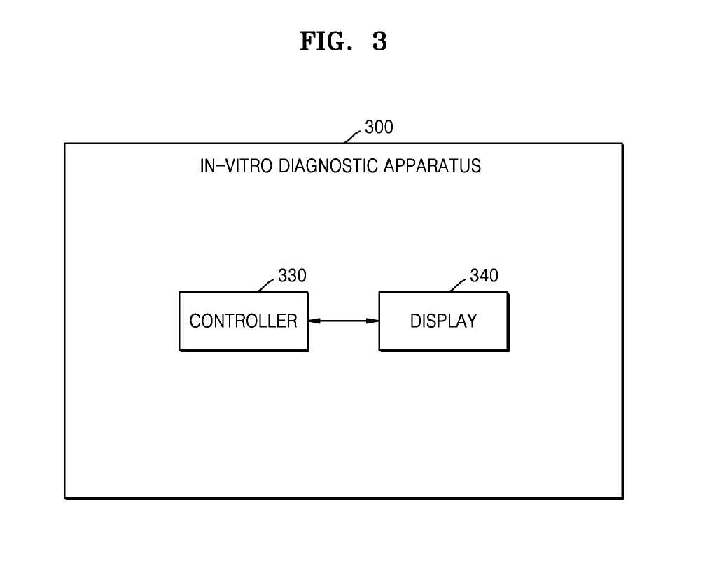

FIG. 3 is a block diagram of an in-vitro diagnostic apparatus 300 according to an exemplary embodiment.

Referring to FIG. 3, the in-vitro diagnostic apparatus 300 according to an exemplary embodiment may include a controller 330 and a display 340.

The controller 330 may set a test result reference range to be applied to a testee, which corresponds to a condition including at least one piece of physical information of the testee, with respect to a test item of a test object, and generate a user interface screen including the test result reference range. For example, the controller 330 may be implemented as a processor such as a central processor unit (CPU), a micro controller unit (MCU), or a micro processor unit (MPU).

A user may set the test item to analyze the test object. As described above, the disc-type blood test apparatus 100a as shown in FIG. 1A or the cartridge-type blood test apparatus 100b as shown in FIG. 1B may be used, a user may set TnI test items to diagnose acute myocardial infarction (AMI) and/or acute coronary syndrome (ACS). As another example, when the disc-type blood test apparatus 100a or the cartridge-type blood test apparatus 100b is used, a user may set a test item for checking a red blood cell count, a white blood cell count, and platelets in blood, etc. That is, the user may define an analysis target of the test object by setting a test item.

Exemplary embodiments are not limited to one test item and a plurality of test items may be set if needed. A result of testing a plurality of test items may be obtained by performing a test once. Also, a user may determine whether a patient is infected with a plurality of diseases from a combination of results of testing the plurality of test items.

A related art in-vitro diagnostic apparatus provides a reference range for each test item to determine whether a test result is normal. The reference range is, however, not an absolute reference range for determining the health of a testee, e.g., whether the testee is diagnosed with a disease but is used as a reference for a doctor or a user to determine the health of the testee. In detail, when a test result of a test item is within the test result reference range, the test result may be used for a user to determine whether the health of the testee is normal.

According to an exemplary embodiment, the in-vitro diagnostic apparatus 300 may take into account, for example, physical information of the testee in setting a test result reference range for a test item of a test object. In detail, the in-vitro diagnostic apparatus 300 may provide a database of test result reference ranges corresponding to various conditions, and set a test result reference range for a testee by detecting a test result that is applicable to the testee. Alternatively, a user may set a test result reference range for a testee by selecting a condition of the testee.

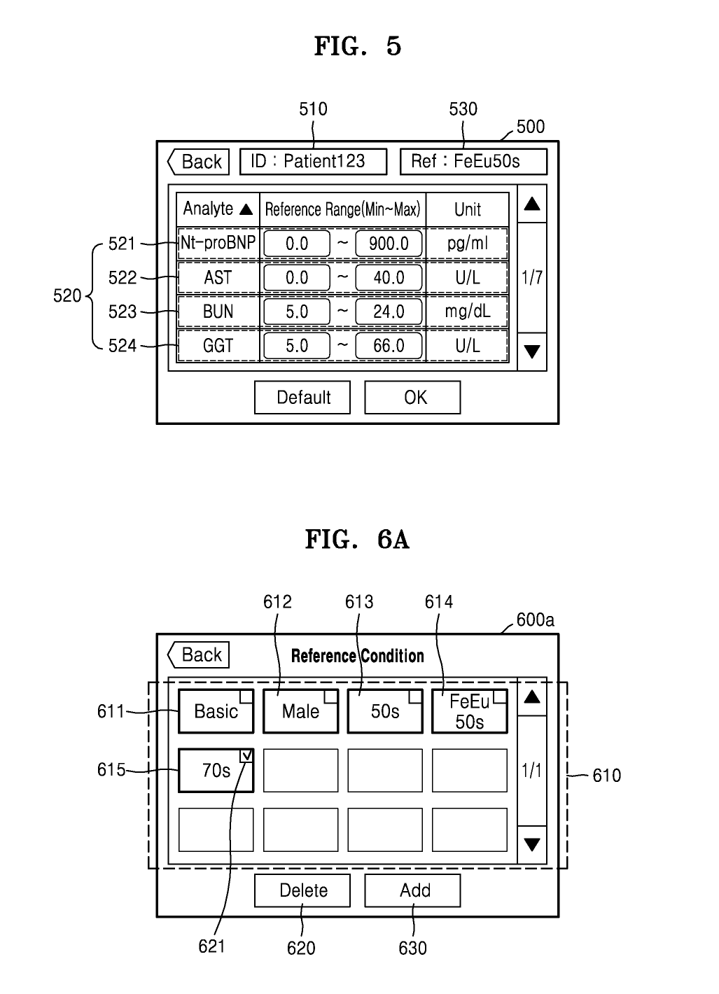

A method of setting a test result reference range by using the in-vitro diagnostic apparatus 300, according to an exemplary embodiment, will be described in detail with reference to FIGS. 5 to 12 later.

The display 340 may display a user interface screen. The display 340 of FIG. 3 may correspond to the display 140a of FIG. 1 or 140b of FIG. 1B. Thus, repetitive descriptions are omitted.

FIG. 4 is a block diagram of an in-vitro diagnostic apparatus 400 according to another exemplary embodiment.

The in-vitro diagnostic apparatus 400 of FIG. 4 may include a storage 410, a user interface 420, a controller 430, a display 440, a loader 450, and an analyzer 460. The controller 430 and the display 440 of the in-vitro diagnostic apparatus 400 of FIG. 4 may correspond to the controller 330 and the display 340 of FIG. 3, respectively. Thus, repetitive descriptions are omitted.

The storage 410 may store test result reference ranges corresponding to a plurality of respective conditions including at least one piece of physical information of the testee with respect to a test item of a test object.

As described above, a test result reference range of a test item may depend on physical information of a testee. Here, the physical information may include at least one from among the race, gender, age, height, and weight of a testee. In addition, the physical information may include other various information regarding the testee, e.g., blood type, DNA information, whether the testee has an antigen and an antibody, etc.

For example, a normal red blood cell count may depend on the gender of the testee. For example, a normal red blood cell count is 4.2×10⁶/uL to 6.3×10⁶/uL when the testee is a male, and is 4.0×10⁶/uL to 5.4×10⁶/uL when the testee is a female. Here, ‘/uL’, which is a unit of the red blood cell count, may be understood as a red blood cell count per microliter.

Thus, the storage 410 may store different test result reference ranges according to the gender of a testee. When a user checks a red blood cell count in blood by using the in-vitro diagnostic apparatus 400 according to an exemplary embodiment, the controller 430 may set a test result reference range according to the gender of the testee.

As described above, the controller 430 may set a test result reference range to be applied to the testee, based on a first test result reference range according to a first condition corresponding to the testee among a plurality of conditions stored in the storage 410. For example, the controller 430 may be implemented as a processor such as a central processor unit (CPU), a micro controller unit (MCU), or a micro processor unit (MPU).

The storage 410 may further store various data, test results, programs needed to perform an in- vitro diagnosis, etc. Also, the storage 410 may include at least one storage medium among a flash memory type storage medium, a hard disk type storage medium, a multimedia card micro type storage medium, a card type memory (e.g., a secure digital (SD) memory, an extreme digital (XD) memory, etc.), a random access memory (RAM), a static RAM (SRAM), a read-only memory (ROM), an electrically erasable programmable ROM (EEPROM), a programmable ROM (PROM), a magnetic memory, a magnetic disk, an optical disc, etc.

An input for setting a test result reference range to be applied to the testee may be provided to the user interface 420 via a user interface screen. An operation of the user interface 420 will be described in detail with reference to FIGS. 5 to 11 later.

The user interface 420 may include a device for receiving an input from the outside, etc. For example, the user interface 420 may include an input device such as a mouse, a keyboard, hard keys for inputting data, etc.

In an exemplary embodiment, the user interface 420 may be provided in the form of a touch pad. The user interface 420 may include a touch pad (not shown) combined with a display panel (not shown) that is included in the display 440. Also, the display 440 displays the user interface screen on the display panel. When a user inputs a command by touching the user interface screen, the touch pad may sense a touch location and detect the command input by the user.

When the user interface 420 is provided as a touch pad and a user touches the user interface screen, the user interface 420 may sense the touched location and transmit sensed information to the controller 430. Then, the controller 430 may detect the user's request or command corresponding to the sensed information and perform the request or command.

A user may manipulate at least one from among the mouse, the keyboard, the touch pad, and other input devices included in the user interface 420 to set a test result reference range to be applied to a testee.

A test medium is loaded in the loader 450. The test medium should be understood as a medium containing a test object (such as blood, body fluid, etc.) obtained from the testee. The loader 450 may corresponds to the loader 110a of FIG. 1A or the loader 110b of FIG. 1B. In detail, the loader 450 may include a medium insertion device via which a test medium is loaded therein. The form of the loader 450 may depend on the test medium.

FIG. 1A illustrates a case in which a test medium has a disc form. In this case, the loader 110a may include a disc tray (not shown) as a medium insertion device into which a disc is inserted.

In detail, the loader 110a may drive the disc tray to pop out so that a disc may be loaded on the disc tray.

As another example, FIG. 1B illustrates a case in which a test medium has a cartridge form. In this case, the loader 110b may have a medium insertion device into which a cartridge is inserted. The form of the loader 450 may depend on the form of the test medium, and the loader 450 may have various forms.

Also, when a trigger signal indicating start of a test is input to the controller 430, the controller 430 drives the loader 450 to receive a test medium and to start an analysis of a test object.

Also, the analyzer 460 may analyze the test object under control of the controller 430. The analyzer 460 may analyze the test object such as blood and generate a test result, e.g., whether a testee is infected with a predetermined disease. Also, the user may compare the test result generated by the analyzer 460 with a test result reference range applied to the testee to evaluate the health of the testee.

FIG. 5 is a diagram illustrating an operation of an in-vitro diagnostic apparatus, according to an exemplary embodiment.

FIG. 5 illustrates a user interface screen 500 including a test result reference range to be applied to a testee with respect to a test item 520 of a test object.

For example, a user sets a test item 520 including an N-terminal pro B-type natriuretic (NT-proBNP) 521, an aspartate aminotransferase (AST) 522, a blood urea nitrogen (BUN) 523, and a gamma glutamyl transferase (GGT) 524 with respect to a testee whose ID 510 is ‘Patient123’.

The NT-proBNP 521 is used, as a biochemical indicator for diagnosing cardiac insufficiency, to diagnose acute respiratory distress or cardiac insufficiency, determine a prognosis thereof, etc. Also, a test result reference range for NT-proBNP 521 varies according to the age of the testee. For example, a reference range is 0.0 to 450 pg/ml when the testee's age is less than 50, 0.0 to 900 pg/ml when the testee's age is equal to or greater than 50 and less than 75, and is 0.0 to 1800 pg/ml when the testee's age is equal to or greater than 75. Here, ‘pg/ml’, which is a unit of the NT-proBNP 521, means pictogram/millimeter.

An activity of the AST 522 in serum increases when the testee has a liver complaint, a biliary tract disease, myocardial infarction, etc., and particularly, acute hepatitis. In general, the AST has a reference range of 0.0 to 40.0 U/L. Here, ‘U/L’, which is a unit of the AST, means unit/liter.

The BUN 523, which indicates an urea nitrogen content contained in blood, is not excreted from a kidney and thus accumulated in a body when the function of the kidney decreases. Accordingly, the function of the kidney may be measured based on BUN 523. In general, the BUN 523 has a reference range of 5.0 to 24.0 mg/dL. Here, mg/dL, which is a unit of the BUN 523, means milligram/deciliter.

The GGT 524 is an enzyme that is widely distributed in the kidney, a pancreas, a prostate, the liver, etc. The activity of the GGT 524 contained in serum increases mainly when the testee has obstructive jaundice, liver cancer, or alcoholic liver injury. In general, the GGT 524 has a reference range of 5.0 to 66.0 U/L. Here, ‘U/L’, which is a unit of the GGT 524, means a unit/liter.

In addition to the NT-proBNP 521, the AST 522, the BUN 523, and the GGT 524, the test item 520 may be set variously according to a user's need.

Hereinafter, it is assumed for convenience of explanation that the testee whose ID 510 is ‘Patient123’ is an European female who is in her fifties.

In the case of a related art in-vitro diagnostic apparatus, a reference range of the NT-proBNP 521 may be set to 0.0 to 450.0 pg/ml as a default range regardless of the age of the testee. Thus, in the related art, a user needs to perform an in-vitro diagnosis by modifying the above reference range according to circumstances.

On the other hand, the in-vitro diagnostic apparatuses 300 and 400 according to exemplary embodiments are capable of providing a reference range according to the age of a testee. For example, the in-vitro diagnostic apparatuses 300 and 400 according to exemplary embodiments may set a reference range of the NT-proBNP 521 to 0.0 to 900 pg/ml with respect to the testee whose ID 510 is ‘Patient123’.

The user interface screen 500 including the test result reference range to be applied to the testee may further include an icon 530 representing a condition for the testee. For example, the testee whose ID 510 is ‘Patient123’ may correspond to a ‘FeEu50s’ condition based on physical information of a female, a European, and in an age group of fifties.

Also, the in-vitro diagnostic apparatuses 300 and 400 according to exemplary embodiments may set a test result reference range to be applied to the testee with respect to the test item 520 of the test object, based on the ‘FeEu50s’ condition.

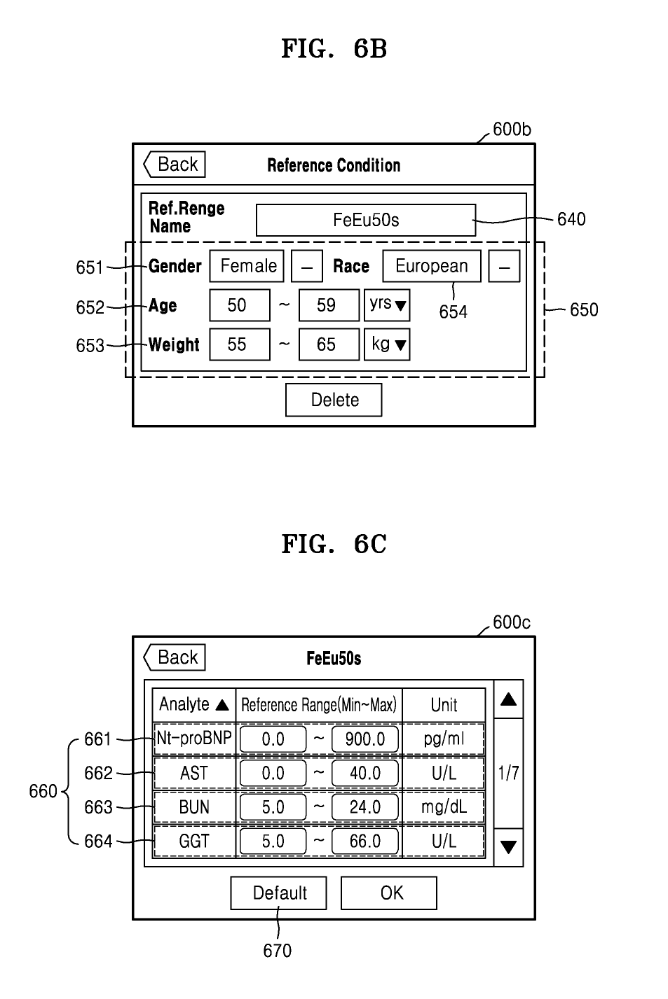

A method of setting a reference range for the testee whose ID 510 is ‘Patient123’ by using the in-vitro diagnostic apparatus 300 or 400 will be described in detail with reference to FIGS. 6 to 12 later.

FIGS. 6A, 6B, and 6C are diagrams illustrating operations of an in-vitro diagnostic apparatus according to other exemplary embodiments. FIGS. 6A, 6B, and 6C illustrate user interface screens 600a, 600b, and 600c for adding, modifying, or deleting a plurality of conditions 610 stored in the storage 410 of FIG. 4 and test result reference ranges corresponding to the plurality of conditions 610.

A first input for adding, modifying, or deleting the plurality of conditions 610 stored in the storage 410 of FIG. 4 and the test result reference ranges corresponding to the plurality of conditions 610 may be input to the user interface 420 of FIG. 4.

The controller 330 or 430 may add, modify, or delete the plurality of conditions 610 and the test result reference ranges corresponding to the plurality of conditions 610, based on the first input.

FIG. 6A illustrates the user interface screen 600a including the plurality of conditions 610 including at least a piece of the physical information stored in the storage 410. The plurality of conditions 610 includes a ‘Basic’ condition 611 for setting a default reference range regardless of the physical information, a ‘Male’ condition 612 for setting a reference range for a male, a ‘50s’ condition 613 for setting a reference range for a testee who is in the age group of fifties, a ‘FeEu50s’ condition 614 for setting a reference range for a testee who is a European female in the age group of fifties, and a ‘70s’ condition 615 for setting a reference range for a testee who is in an age group of seventies.

An input for adding a new condition to the plurality of conditions 610 may be input to the user interface 420. For example, a user may press an ‘Add’ button 630 to add a new condition, set the name of the new condition, at least one piece of physical information regarding the new condition, and a test result reference range for at least one test item based on the new condition, and store a result of the setting in the storage 410.

Also, the user interface 420 may receive an input for deleting a condition among the plurality of conditions 610 and a reference range corresponding to the condition. For example, a user may check a check box 621 of the ‘70s’ condition 615 and press a ‘Delete’ button 620 to delete the ‘70s’ condition 615 and a reference range corresponding to the ‘70s’ condition 615 from the storage 410.

Also, the user interface 420 may receive an input for modifying a condition among the plurality of conditions 610 and a reference range corresponding to the condition. Operations of the in-vitro diagnostic apparatuses 300 and 400 for modifying a condition and a reference range corresponding to the condition will be described with reference to FIGS. 6B and 6C below.

For example, as shown in FIG. 6B, an input for modifying at least one piece of physical information 650 included in a condition 640 named ‘FeEu50s’ may be input to the user interface 420 via the user interface screen 600b. The ‘FeEu50s’ condition 640 may include physical information according to a gender 651, a race 654, a weight 653, and an age 652.

Referring to FIG. 6B, a user modifies or sets the physical information of the gender 651 included in the ‘FeEu50s’ condition 640 to female, sets the physical information of the race 654 to European, and sets the physical information of the age 652 to 50 to 59 years old. Also, the user may modify or set the physical information of the weight 653 to 55 to 65 kg.

In addition, the user may modify the name of the ‘FeEu50s’ condition 640 or set additional physical information if needed.

Also, for example, an input for modifying a test result reference range 660 corresponding to the ‘FeEu50s’ condition 640 may be performed via the user interface 420, as shown in the user interface screen 600c of FIG. 6C.

Referring to FIG. 6C, the test result reference range 660 of a ‘FeEu50s’ condition includes reference ranges corresponding to an NT-proBNP 661, an AST 662, a BUN 663, and a GGT 664, which are test items of a test object. For example, in the ‘FeEu50s’ condition, a reference range of the NT-proBNP 661 may be set as 0.0 to 900.0 pg/ml, a reference range of the AST 662 may be set as 0.0 to 40.0 U/L, a reference range of the BUN 663 may be set as 5.0 to 24.0 mg/dL, and a reference range of the GGT 664 may be set as 5.0 to 66.0 U/L.

In addition, the ‘FeEu50s’ condition may include reference ranges for various test items such as a red blood cell count, a white blood cell count, a serum count, etc. contained in blood.

A user may add, modify, or delete a test item and a reference range of the test item with respect to each of the plurality of conditions 610 stored in the storage 410.

As described above, the plurality of conditions 610 stored in the storage 410, physical information included in the plurality of conditions 610, and test result reference ranges corresponding to the plurality of conditions 610 may be modified by a user to have arbitrary values as needed.

Also, the in-vitro diagnostic apparatuses 300 and 400 according to exemplary embodiments may provide a test result reference range that is appropriate for a testee, based on test result reference ranges corresponding to a plurality of conditions stored in the storage 410, which may be provided as a database.

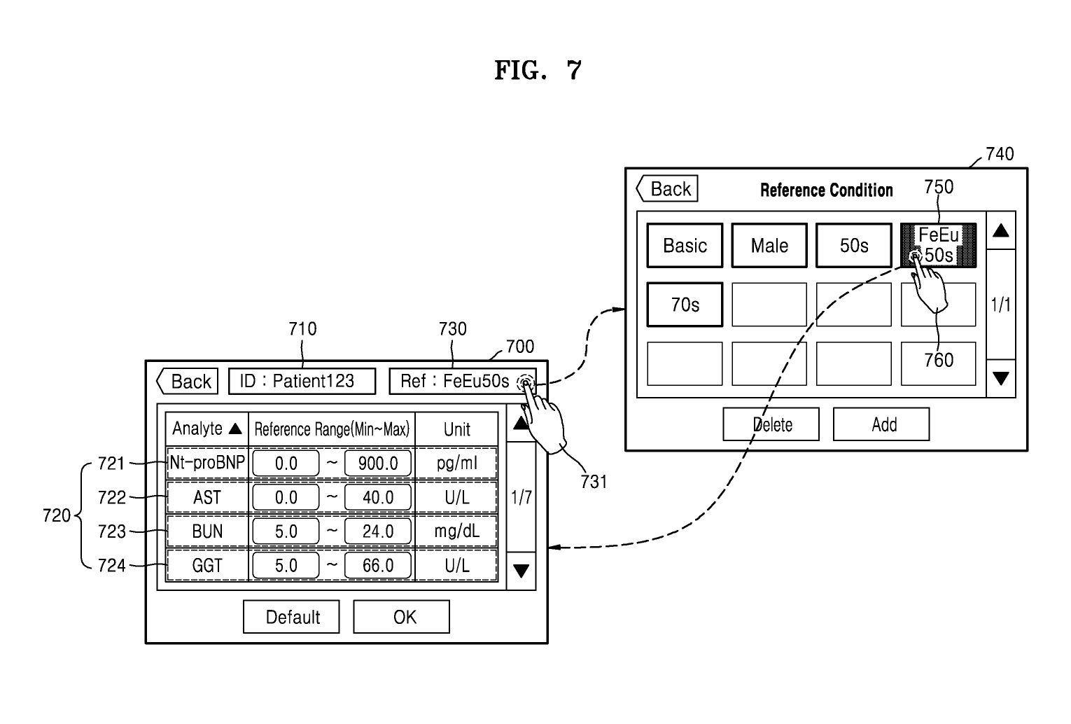

FIG. 7 is a diagram illustrating an operation of an in-vitro diagnostic apparatus, according to still another exemplary embodiment.

FIG. 7 illustrates a user interface screen 700 for setting a test result reference range 720 to be applied to a testee, based on a first test result reference range according to a first condition 750 corresponding to the testee among a plurality of conditions stored in the storage 410.

In detail, when the user interface 420 receives an input 731 through an icon 730 included in the user interface screen 700, a user interface screen 740 for selecting the first condition 750 among the plurality of conditions stored in the storage 410 may be displayed on the display 440 of FIG. 4. The user interface screen 740 may be a popup window.

Also, a second input 760 for selecting the first condition 750 may be input via the user interface 420 by using the user interface screen 740. Referring to FIG. 7, a user selects a ‘FeEu50s’ condition as the first condition 750.

The controller 330 or 430 may set the test result reference range 720 to be applied to the testee, based on the second input 760. That is, the test result reference range 720 to be applied to the testee may be a first test result reference range corresponding to the first condition 750.

Specifically, referring to FIG. 7, test items of a testee whose ID 710 is ‘Patient123’ are set to include an NT-proBNP 721, an AST 722, a BUN 723, and a GGT 724. Thus, the test result reference range 720 of the NT-proBNP 721, the AST 722, the BUN 723, and the GGT 724 of FIG. 7, which are test items, may be set as the test result reference range 660 for the NT-proBNP 661, the AST 662, the BUN 663, and the GGT 664 as shown in FIG. 6C according to the ‘FeEu50s’ condition, which is the first condition 750.

As described above, the in-vitro diagnostic apparatuses 300 and 400 are capable of setting the test result reference range 720 to be applied to the testee according to the first condition 750 among the plurality of conditions stored in the storage 410, based on the second input 760 without receiving testee conditions including physical information of the testee.

According to an exemplary embodiment, a user may input a testee condition to the in-vitro diagnostic apparatus 300 or 400 according to the user's need and/or test purpose. For example, the user may determine whether the first condition 750 selected by the user and the testee condition correspond to each other, obtain a test result analysis including the testee condition, or allow the in-vitro diagnostic apparatus 300 or 400 to automatically detect the first condition 750 corresponding to the testee condition. Here, the testee condition may include at least one from among the race, gender, age, height, and weight of a testee.

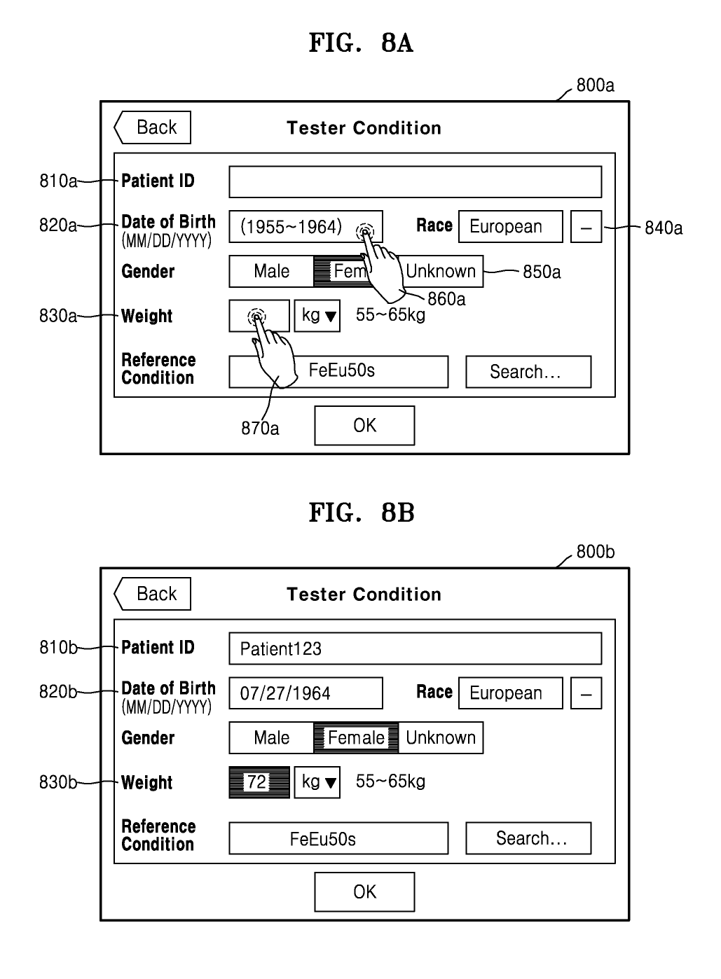

Operations of receiving a testee condition in the in-vitro diagnostic apparatuses 300 and 400 according to other exemplary embodiments will be described in detail with reference to FIGS. 8A to 12 below.

FIGS. 8A and 8B are diagrams illustrating an operation of an in-vitro diagnostic apparatus, according to still other exemplary embodiment. In detail, FIG. 8A illustrates a user interface screen 800a including a testee condition set based on the first condition 750 of FIG. 7.

According to an exemplary embodiment, the controller 330 or 430 may set a testee condition including at least one piece of physical information of the testee, based on the first condition 750 selected according to the second input 760.

Based on assumption that a part or all of physical information included in the first condition 750 selected according to the second input 760 may correspond to the physical information of the testee, the in-vitro diagnostic apparatus 300 or 400 may automatically set some or all of the testee conditions to increase user convenience.

For example, as illustrated in FIG. 7, a user selects the ‘FeEu50s’ condition as the first condition 750. Thus, the controller 330 or 430 may set physical information of a race 840a as European and physical information of a gender 850a as female, based on the physical information included in the ‘FeEu50s’ condition selected as the first condition 750. Thus, the user does not need to additionally input the physical information of the race 840a and the gender 850a of the testee.

FIG. 8B illustrates a user interface screen 800b including a result of modifying the testee condition that is set in the exemplary embodiment of FIG. 8A or additionally inputting testee condition.

As shown in FIG. 8A, third inputs 860a and 870a for modifying the testee condition that is set based on the first condition 750 selected according to the second input 760 may be input to the user interface 420. Also, the controller 330 or 430 may generate a first notification signal when the modified testee condition does not match the selected first condition 750.

Here, the controller 330 or 430 determines that the modified testee condition matches the selected first condition 750 when some or all of the physical information of the testee included in the modified testee condition are substantially the same as or included in corresponding physical information included in the first condition 750. For example, when the gender and the race of the testee are the same as the gender and the race included in the first condition 750, the controller 330 or 430 determines that the testee condition matches the first condition 750.

Physical information included in only the testee condition or the first condition 750 may not be used as a criterion for determining whether the testee condition and the first condition 750 match each other. For example, when the testee condition further includes physical information of a blood type, which is not included in the first condition 750, the physical information of the blood type may not be used as a criterion for determining whether the testee condition and the first condition 750 match each other.

That is, a user may modify physical information of a testee that is set according to the first condition 750. For example, when the physical information that is set according to the first condition 750 is not correct physical information of the testee, the user may modify the corresponding physical information.

For example, in the ‘FeEu50s’ condition, which is the first condition 750 selected in the exemplary embodiment of FIG. 7, the physical information of the age 652 is set to have a range of 50 to 59. Thus, the controller 330 or 430 may not set physical information of a date of birth 820a of the testee. Thus, a year of birth of the testee is not displayed on the user interface screen 800a of FIG. 8A.

As shown in FIG. 8A, the year of birth of the testee is indicated as being in a range of 1955 to 1964 corresponding to the age group of fifties with respect to the year of 2014 when an in-vitro diagnosis is performed. Thus, the controller 330 or 430 may display the year range of 1955 to 1965, which is the physical information of the age 652 of the first condition 750, as the physical information of the date of birth 820a of the testee.

Similarly, in the ‘FeEu50s’ condition, which is the first condition 750, the physical information of the weight 653 is set to have a range of 55 to 65 kg. That is, the controller 330 or 430 may display the range of 55 to 65 kg, which is the physical information of the weight 653 included in the first condition 750, as physical information of the weight 830a of the testee. Therefore, when the weight of the testee is out of the range of 55 to 65 kg, the controller 330 or 430 may not correctly set the physical information of the weight of the testee.

Thus, a user may modify the physical information of the date of birth 820a of the testee to be Jul. 27, 1964, as illustrated in FIG. 8B. The modified physical information of the date of birth 820a of the testee matches the physical information of the age 652 of the testee included in the ‘FeEu50s’ condition, which is the first condition 750.

The user may modify the physical information of the weight 830b of the testee to be 72 kg, as illustrated in FIG. 8B. The modified physical information of the weight 830b of the testee does not match the physical information of the weight 653 included in the ‘FeEu50s’ condition, which is the first condition 750. The modified physical information of the weight 830b of the testee may be an actual weight of the testee or may be erroneously input by a user.

In this case, the controller 330 or 430 may generate a first notification signal indicating that the modified testee condition does not match the first condition 750. In detail, the controller 330 or 430 may generate the first notification signal when the physical information included in the modified testee condition is not included in or is not the same as the physical information of the first condition 750.

The first notification signal may include at least one of a visual signal, a tactile signal, and an audio signal.

For example, the controller 330 or 430 may generate the user interface screen 800b such that physical information of the testee that does not match the first condition 750 is displayed in a different color. Referring to FIG. 8B, the modified physical information of the weight 830b of the testee does not match the first condition 750 and is thus displayed with a shading.

As another example, when the physical information of the testee that does not match the first condition 750 is input, the controller 330 or 430 may generate warning sound and output the warning sound through a speaker (not shown).

As described above, the in-vitro diagnostic apparatus 300 or 400 according to various exemplary embodiments may generate the first notification signal to inform the user that the testee condition and the first condition 750 do not match each other.

The user may detect that at least some of test result reference ranges applied to the testee is incorrect, based on the first notification signal. Also, the user may modify the erroneously input test result reference range.

In addition, the user may set additional information that is not included in the physical information of the first condition 750. For example, the user may additionally input the identification, blood type, DNA information, etc. of the testee, whether the testee has an antibody, and the like.

As shown in FIG. 8A, the physical information of the first condition 750 may not include an ID 810a of the testee. Thus, the user may set an ID 810b of the testee to ‘Patient123’.

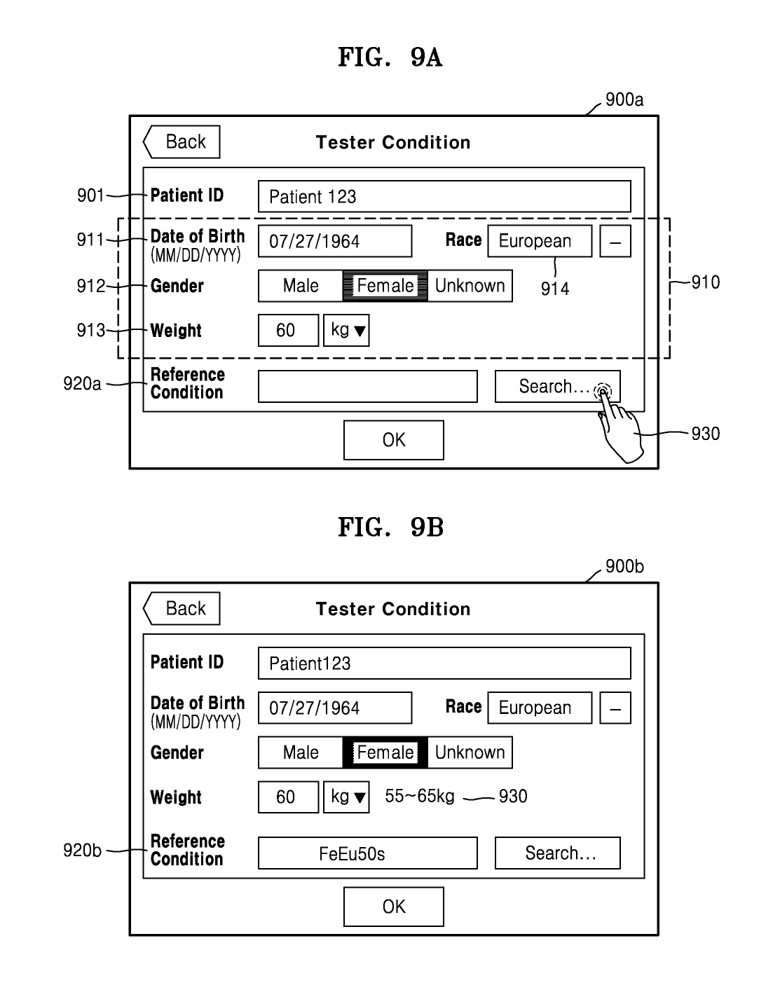

FIGS. 9A and 9B are diagrams illustrating an operation of an in-vitro diagnostic apparatus, according to still another exemplary embodiment. Specifically, FIG. 9A illustrates a user interface screen 900a including a testee condition 910 input by a user. FIG. 9B illustrates a user interface screen 900b further including a first condition 920b matching the testee condition 910, compared to the user interface screen 900a of FIG. 9A.

A fourth input for setting the testee condition 910 including at least one piece of physical information of a testee may be input to the user interface 420.

Referring to FIG. 8A, the controller 330 or 430 sets testee conditions based on the second input 760 for selecting the first condition 750 among the plurality of conditions stored in the storage 410. On the other hand, referring to FIG. 9A, a user may directly input the testee condition 910 without selecting the first condition 920b.

For example, a fourth input for setting an ID 901 of the testee to ‘Patient123’, physical information of a date of birth 911 to ‘Jul. 27, 1964’, physical information of a race 914 to European, physical information of a gender 912 to female, and physical information of a weight 913 to 60 kg may be input via the user interface 420.

The controller 330 or 430 may detect the first condition 920b matching the testee condition 910 input by the user among the plurality of conditions 610 stored in the storage 410. Also, the controller 330 or 430 may set a test result reference range to be applied to the testee, based on a first test result reference range according to the detected first condition 920b.

As described above, the controller 330 or 430 determines that the first condition 920b matches the testee condition 910 when some or all of the physical information 911, 912, 913, and 914 included in the testee condition 910 are substantially the same as or included in corresponding physical information included in the first condition 920b. For example, when the gender 912 and the race 914 of the testee are the same as a gender and a race included in the first condition 920b, the controller 330 or 430 determines that the testee condition 910 and the first condition 920b match each other.

Physical information included in only the testee condition 910 or the first condition 920b may not be used as a criterion for determining whether the testee condition 910 and the first condition 920b match each other. For example, when the testee condition 910 further includes physical information of a blood type, which is not included in the first condition 920b, the physical information of the blood type may not be used as a criterion for determining whether the testee condition 910 and the first condition 920b match each other.

Referring to FIG. 9A, an input 930 for detecting the first condition 920b that matches the testee condition 910 may be input via the user interface 420 after the fourth input is input. In response to the input 930, the controller 330 or 430 may detect the first condition 920b that matches the testee condition 910 by comparing the plurality of conditions 610 stored in the storage 410 with the testee condition 910 input by the user.

Referring to FIG. 9B, the controller 330 or 430 detects a ‘FeEu50s’ condition as a first condition (or reference condition) 920b according to the testee condition 910 of the testee whose ID 901 is ‘Patient123’. Thus, the controller 330 or 430 may set a test result reference range to be applied to the testee whose ID 901 is ‘Patient123’, based on a first test result reference range according to the ‘FeEu50s’ condition, which is the first condition 920b.

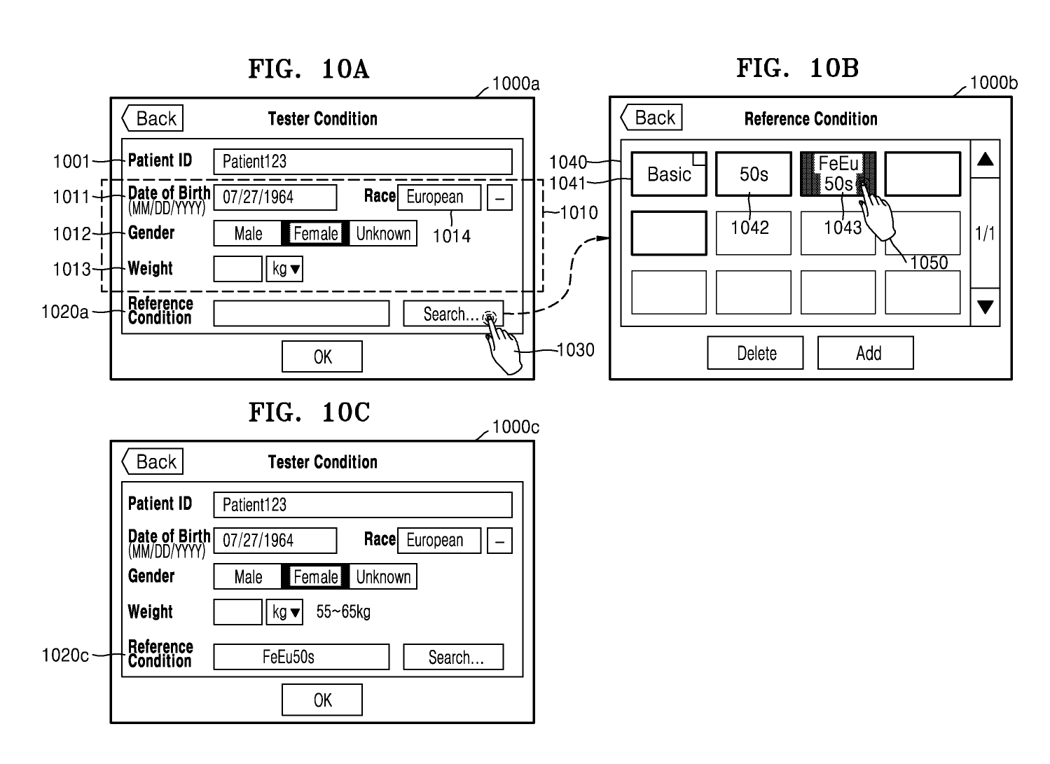

FIGS. 10A, 10B, and 10C are diagrams illustrating an operation of an in-vitro diagnostic apparatus, according to still another exemplary embodiment. In detail, FIG. 10A illustrates a user interface screen 1000a including a testee condition 1010 input by a user. FIG. 10B illustrates a user interface screen 1000b including at least one second condition 1041, 1042, and 1043 matching the testee condition 1010 of FIG. 10A, which is input by the user. FIG. 10C illustrates a user interface screen 1000c further including a first condition 1020c selected among the least one second condition 1041, 1042, and 1043 of FIG. 10B.

Referring to FIG. 10A, a fourth input for setting an ID 1001 of a testee to ‘Patient123’, physical information of a date of birth 1011 to Jul. 27, 1964, and physical information of a gender 1012 to female may be input via the user interface 420. The testee condition 1010 of FIG. 10 does not set physical information of a race 1014 and a weight 1013, compared to the testee condition 910 of FIG. 9. A user may intentionally not input the race 1014 and the weight 1013 to exclude the race 1014 and the weight 1013 from a matching condition. Or, a user may intentionally not input the race 1014 and the weight 1013 since the race 1014 and the weight 1013 are not important with respect to a test item or are unknown.

The controller 330 or 430 may detect at least one second condition (e.g., second conditions 1041, 1042, and 1043) matching the testee condition 1010 input by the user among the plurality of conditions 610 stored in the storage 410. For example, an input 1030 for detecting at least one second condition matching the testee condition 1010 may be input via the user interface 420 after the fourth input is input. In response to the input 1030, the controller 330 or 430 may compare the plurality of conditions stored in the storage 410 with the testee condition 1010 input by the user to detect at least one second condition (e.g., the second conditions 1041, 1042, and 1043) matching the testee condition 1010.

Referring to FIG. 10B, the second conditions 1041, 1042, and 1043 may correspond to an age according to the date of birth 1011 and the gender 1012, i.e., female gender of the testee.

The ‘Basic’ condition 1042 may be always detected as the second condition 1041 regardless of the testee condition 1010. The ‘Basic’ condition 1042 as the second condition 1041 may provide a default test result reference range for a test item regardless of the testee condition 1010.

The ‘50s’ condition as the second condition 1042 matches a test condition for an age group of 50 to 59. Thus, the physical information of the age of the testee is included in the ‘50s’ condition as the second condition 1042 according to physical information of the date of birth 1011 of the testee. Thus, the ‘50s’ condition as the second condition 1042 is detected as a second condition. Since the ‘50s’ condition as the second condition 1042 does not include physical information of a gender, the physical information of the gender 1012 included in the testee condition 1010 may be excluded from a criterion for determining whether matching occurs between the testee condition 1010 and the plurality of conditions stored in the storage 410.

The ‘FeEu50s’ condition as the second condition 1043 matches a testee condition for a European female whose age group is 50 to 59. Thus, the physical information of the age of the testee is included in the ‘FeEu50s’ condition as the second condition 1043 and the physical information of the gender of the testee is the same as the physical information of the gender 1012, i.e., a female. Thus, the ‘FeEu50s’ condition as the second condition 1043 is detected as a second condition. Also, since the testee condition 1010 does not include physical information of the race 1014, the physical information of the race included in the ‘FeEu50s’ condition as the second condition 1043 may be excluded from a criterion for determining whether matching occurs between the testee condition 1010 and the plurality of conditions stored in the storage 410.

A fifth input 1050 for selecting the first condition 1020c (or reference condition) among the second conditions 1041, 1042, and 1043 may be input to the user interface 420.

The controller 330 or 430 may set a test result reference range to be applied to the testee, based on a first test result reference range according to the selected first condition 1020c.

Referring to FIG. 10B, a user selects the ‘FeEu50s’ condition 1043 as the first condition 1020c that matches the testee condition 1010 for the testee whose ID 1001 is ‘Patient123’. Thus, the controller 330 or 430 may set the test result reference range to be applied to the testee whose ID 1001 is ‘Patient123’, based on a first test result reference range according to the ‘FeEu50s’ condition which is selected as the first condition 1020c.

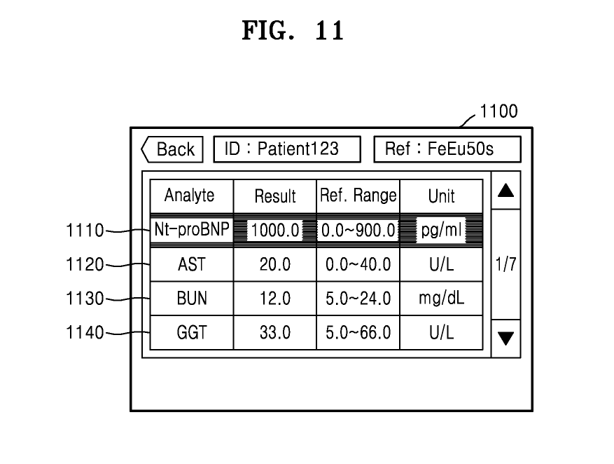

FIG. 11 is a diagram illustrating an operation of an in-vitro diagnostic apparatus, according to still another exemplary embodiment. In detail, FIG. 11 illustrates a user interface screen 1100 including a result of testing a test object by using the in-vitro diagnostic apparatus.

In an exemplary embodiment, the in-vitro diagnostic apparatus 300 or 400 sets a test result reference range to be applied to a testee whose ID is ‘Patient123’, based on a first test result reference range according to a ‘FeEu50s’ condition, which is a first condition. Also, test items, including an NT-proBNP 1110, an AST 1120, a BUN 1130, and a GGT 1140, are set for a test object obtained from the testee whose ID is ‘Patient123’.

As a result of testing the testee by using the analyzer 460, the NT-proBNP 1110 is analyzed as 1000.0 pg/ml and thus exceeds a range of 0.0 to 900.0 pg/ml, which is a reference range for the NT-proBNP 1110. The AST 1120 is analyzed as 20.0 U/L and thus in a range of 0.0 to 40.0 U/L, which is a reference range for the AST 1120. The BUN 1130 is analyzed as 12.0 mg/dL and thus in a range of 5.0 to 24.0 mg/dL, which is a reference range for the BUN 1130. The GGT 1140 is analyzed as 33.0 U/L and thus in a range of 5.0 to 66.0 U/L, which is a reference range for the GGT 1140.

The controller 330 or 430 may generate a second notification signal when the result of testing a test object of the testee by using the analyzer 460 is not in a reference range. The second notification signal may include at least one of a visual signal, a tactile signal, and an audio signal.

For example, as illustrated in FIG. 11, the controller 330 or 430 may generate the second notification signal since the result of testing the testee whose ID is ‘Patient123’ by using the Nt-proBNP 1110 is not in the reference range. For example, the controller 330 or 430 may display the result of testing the testee by using the Nt-proBNP 1110 in a different color or with a shading. Also, the controller 330 or 430 may generate warning sound as the second notification signal and output the warning sound through a speaker (not shown).

A doctor or a user may recognize that the result of testing the testee is not in the reference range, based on the second notification signal.

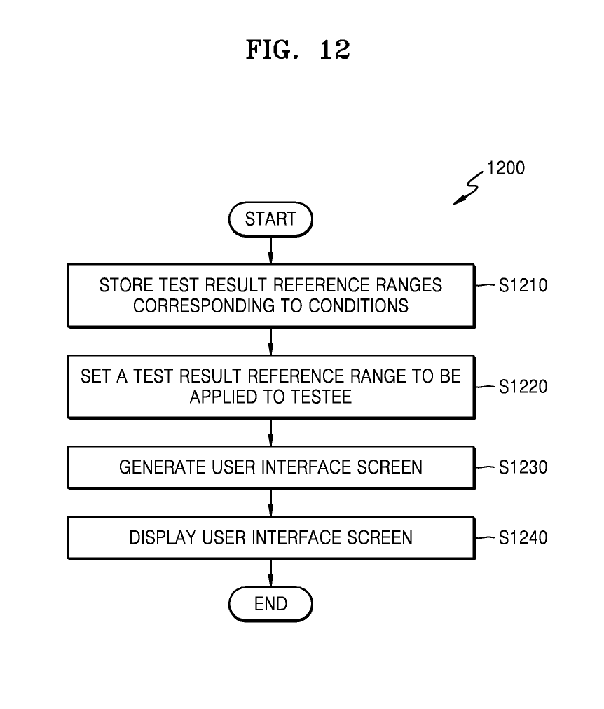

FIG. 12 is a flowchart of an in-vitro diagnostic test method 1200 according to an exemplary embodiment. The in-vitro diagnostic test method 1200 according to an exemplary embodiment may be performed using the in-vitro diagnostic apparatus 300 or 400 according to exemplary embodiments described above with reference to FIGS. 1 to 11. Repetitive description of the components of the in-vitro diagnostic apparatus may be omitted. Also, the in-vitro diagnostic test method 1200 will be described in detail, based on the operations of the in-vitro diagnostic apparatus 300 of FIG. 3 or the in-vitro diagnostic apparatus 400 of FIG. 4.

Referring to FIG. 12, in the in-vitro diagnostic test method 1200 according to an exemplary embodiment, test result reference ranges corresponding to a plurality of respective conditions including at least one piece of physical information of a testee may be stored with respect to a test item of a test object (operation S1210). The test result reference ranges may be stored in the storage 410.

A test result reference range to be applied to a testee are set according to conditions including at least one piece of physical information of the testee with respect to the test item of the test object (operation S1220). Operation S1220 may be performed by the controller 330 or 430.

In operation S1220, the test result reference range to be applied to the testee may be set based on a first test result reference range according to a first condition corresponding to the testee among the plurality of conditions, among the test result reference ranges stored in operation S1210.

A user interface screen including the set test result reference range is generated (operation S1230). Operation S1230 may be performed by the controller 330 or 430.

The user interface screen is displayed (operation S1240). Operation S1240 may be performed by the controller 330 or 430.

In the in-vitro diagnostic test method 1200 according to an exemplary embodiment, an input for setting the test result reference range to be applied to the testee may be received via the user interface screen. The receiving of the input via the user interface screen may be performed by the user interface 420.

As described above, according to the one or more of the above exemplary embodiments, an in-vitro diagnostic apparatus and an in-vitro diagnostic test method are capable of providing different test result reference ranges corresponding to a plurality of conditions with respect to a test item. Also, a user may manage a database by adding a condition or a test result reference range to be stored in the storage or modifying or deleting at least one condition among a plurality of conditions stored in a storage and test result reference ranges corresponding to the plurality of conditions.

According to the one or more of the above exemplary embodiments, an in-vitro diagnostic apparatus and an in-vitro diagnostic test method are capable of automatically detecting a first condition matching a testee condition, thereby decreasing a time required to perform in-vitro diagnosis.

Accordingly, the user may efficiently set a test result reference range that is appropriate for the testee with respect to the test item. Also, the user may precisely check the health of the testee, based on the set test result reference range.

In addition, the in-vitro diagnostic test method according to exemplary embodiments may also be implemented through computer-readable code and/or instructions on a medium, e.g., a computer-readable medium, to control at least one processing element to implement any above-described exemplary embodiment. The medium can correspond to any medium/media permitting the storage and/or transmission of the computer-readable code.

The computer-readable code can be recorded and/or transferred on a medium in a variety of ways, with examples of the medium including recording media, such as magnetic storage media (e.g., ROMs, floppy disks, hard disks, etc.) and optical recording media (e.g., compact disk (CD)-ROMs, or digital versatile disks (DVDs)), and transmission media such as Internet transmission media. Thus, the medium may have a defined and measurable structure including or carrying a signal or information, such as a device carrying a bitstream according to one or more exemplary embodiments. The media may also be a distributed network, so that the computer-readable code is stored and/or transferred and executed in a distributed fashion. Furthermore, the processing element could include a processor or a computer processor, and processing elements may be distributed and/or included in a single device.

At least one of the components, elements or units represented by a block as illustrated in FIGS. 3 and 4 may be embodied as various numbers of hardware, software and/or firmware structures that execute respective functions described above, according to an exemplary embodiment. For example, at least one of these components, elements or units may use a direct circuit structure, such as a memory, processing, logic, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions. Also, at least one of these components, elements or units may further include a processor such as a central processing unit (CPU) that performs the respective functions, a microprocessor, or the like. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

Although a few embodiments have been shown and described, it would be appreciated by those skilled in the art that changes may be made in the exemplary embodiments without departing from the principles and spirit of the disclosure, the scope of which is defined in the claims and their equivalents.

What is claimed is:

1. An in-vitro diagnostic apparatus comprising:
a controller configured to set a test result reference range corresponding to a condition of a testee, among test result reference ranges corresponding to a plurality of conditions with respect to a test item of a test object, and generate a user interface screen including the set test result reference range; and
a display configured to display the user interface screen.

2. The in-vitro diagnostic apparatus of claim 1, further comprising a storage configured to store the plurality of conditions and the test result reference ranges corresponding to the plurality of conditions with respect to the test item of the test object.

3. The in-vitro diagnostic apparatus of claim 2, wherein the controller is configured to set the test result reference range based on a first test result reference range corresponding to a first condition, the first condition matching at least one physical information of the testee.

4. The in-vitro diagnostic apparatus of claim 3, further comprising a user interface configured to receive an input for setting the test result reference range via the user interface screen.

5. The in-vitro diagnostic apparatus of claim 4, wherein the user interface is configured to receive a first input for performing at least one of adding, modifying, or deleting a certain condition or a certain test result reference range with respect to the plurality of conditions and the test result reference ranges corresponding to the plurality of conditions, which are stored in the storage,
wherein the controller is configured to perform the at least one of adding, modifying, or deleting the certain condition or the certain test result reference range based on the first input.

6. The in-vitro diagnostic apparatus of claim 4, wherein the user interface is configured to receive a second input for selecting the first condition among the plurality of conditions.

7. The in-vitro diagnostic apparatus of claim 6, wherein the controller is configured to set the condition of the testee based on the selected first condition.

8. The in-vitro diagnostic apparatus of claim 7, wherein the user interface is configured to receive a third input for modifying the set condition of the testee, wherein the controller is configured to generate a first notification signal when the modified condition of the testee does not match the first condition.

9. The in-vitro diagnostic apparatus of claim 8, wherein the first notification signal comprises at least one from among a visual signal, a tactile signal, and an audio signal.

10. The in-vitro diagnostic apparatus of claim 4, wherein the user interface is configured to receive a fourth input for setting the condition of the testee,
wherein the controller is configured to set, as the condition of the testee, the first condition matching the at least one physical information of the testee among the plurality of conditions, in response to the fourth input.

11. The in-vitro diagnostic apparatus of claim 10, wherein the controller is configured to detect a plurality of first conditions matching the at least one physical information of the testee, among the plurality of conditions,
wherein the user interface is configured to receive a fifth input for selecting the first condition among the plurality of first conditions.

12. The in-vitro diagnostic apparatus of claim 1, wherein the condition of the testee comprises at least one from among a race, a gender, an age, a height, and a weight.

13. The in-vitro diagnostic apparatus of claim 1, further comprising:
a loader configured to load a test medium containing the test object; and
an analyzer configured to analyze the test object in response to a control of the controller.

14. The in-vitro diagnostic apparatus of claim 13, wherein the controller is configured to generate a second notification signal when a result of analyzing the test object is not within the test result reference range.

15. The in-vitro diagnostic apparatus of claim 14, wherein the second notification signal comprises at least one from among a visual signal, a tactile signal, and an audio signal.

16. An in-vitro diagnostic test method comprising:
setting a test result reference range corresponding to a condition of a testee, among test result reference ranges corresponding to a plurality of conditions with respect to a test item of a test object;
generating a user interface screen including the set test result reference range; and
displaying the user interface screen.

17. The in-vitro diagnostic apparatus of claim 16, further comprising storing the plurality of conditions and the test result reference ranges corresponding to the plurality of conditions with respect to the test item of the test object.

18. The in-vitro diagnostic apparatus of claim 17, wherein the setting comprises setting the test result reference range based on a first test result reference range corresponding to a first condition, the first condition matching at least one physical information of the testee.

19. The in-vitro diagnostic apparatus of claim 18, further comprising receiving an input for setting the test result reference range via the user interface screen.

20. A non-transitory computer-readable recording medium having recorded thereon a program which, when executed by a computer, causes the computer to perform an in-vitro diagnostic test method comprising:
setting a test result reference range corresponding to a condition of a testee, among test result reference ranges corresponding to a plurality of conditions with respect to a test item of a test object;
generating a user interface screen including the set test result reference range; and
displaying the user interface screen.
